(19) United States
(12) Patent Application Publication
(10) Pub. No.: US 2013/0150244 A1
(43) Pub. Date: Jun. 13, 2013

(54) Ethane as an Aerosol Propellant

(71) Applicant: Diversified CPC International., Inc., Channahon, IL (US)

(72) Inventors: David Shaw, Channahon, IL (US); William N. Auriemma, Channahon, IL (US)

(73) Assignee: DIVERSIFIED CPC INTERNATIONAL, INC., CHANNAHON, IL (US)

(21) Appl. No.: 13/711,880

(22) Filed: Dec. 12, 2012

Related U.S. Application Data
(60) Provisional application No. 61/569,532, filed on Dec. 12, 2011.

(51) Int. Cl. C09K 3/30

(52) U.S. Cl. CPC C09K 3/30
USPC 504/362; 516/1; 424/47; 512/1; 424/45; 508/110; 106/285; 106/11; 510/438

(57) ABSTRACT

Pressurizing or propellant compositions and products made using the compositions are provided herein. The propellant compositions include ethane as a propellant. The ethane may be the only propellant in the composition or may be mixed with other propellants. The ethane may be the only hydrocarbon or the only saturated hydrocarbon propellant used in the compositions. Sprayable products including the propellants described herein are also provided. Finally methods of removing a contaminate from an article using the sprayable products described herein are also provided.

### CROSS-REFERENCE TO RELATED APPLICATIONS

This patent application claims the benefit of priority of U.S. Provisional Patent Application No. 61/569,532, filed Dec. 12, 2011, which is incorporated herein by reference in its entirety.

### BACKGROUND

Many products designed for household, personal or industrial use are available as aerosol products. Typical examples of such products and ones in which the propellant compositions and products described herein can be used include household products such as waxes, polishes, room fresheners, cleaners, dusters, and insecticides; industrial products such as cleaners and lubricants; and automotive or gun products such as cleaners and polishes. All such products utilize the pressure of a propellant gas or a mixture of propellant gases (i.e., a propellant gas system) to expel the active ingredients from the container. In some cases, the propellant gases are the product such as in dusters. For this purpose, most aerosols employ liquefied gases which vaporize and provide the pressure to propel the active ingredients when the valve on the aerosol container is pressed open.

Consumer products and in particular aerosol or sprayable products have been in constant flux since the 1970s. Beginning with ozone depletion and the phase out of chlorofluorocarbons (CFCs), we have seen a never ending array of chemicals being eliminated or restricted. Whether it's to address particulates, global warming, or toxicity, the demands on the chemical industry have continued to increase. While some new chemical groups are being created, it is difficult to continue to formulate products that are safe and effective, while keeping the unit cost reasonable.

### SUMMARY

Provided herein are pressurizing or propellant compositions and continuous or aerosol spray products comprising these compositions. In one aspect, a pressurizing or propellant composition comprising at least 1% ethane by weight and with ethane as the only hydrocarbon propellant in the composition is provided. In another aspect, a pressurizing or propellant composition comprising at least 5% ethane by weight is provided.

In yet another aspect, continuous spray products comprising the pressurizing compositions described herein are provided. In at least one embodiment, the continuous spray product comprises at least 1% ethane by weight.

In yet another aspect, sprayable cleaners, pesticides and disinfectants made using the pressurizing or propellant compositions described herein are provided.

In still another aspect, methods of removing a contaminant from an article or portion thereof by applying the product provided herein to the article are provided. In these methods the continuous spray product includes a material to be sprayed that is a cleaner or polisher.

### DETAILED DESCRIPTION

To be useful as an aerosol propellant, a chemical must first be free of contaminants such as moisture, reactive chemicals, and not possess an objectionable odor. In addition, the propellant must not react in the normal environment of the aerosol, must be soluble in common solvents and propellants, and should be formulated such that the propellant and final product has a low level of volatile organic compounds (VOC) and/or is not a significant global warmer. Finally, the propellant must be capable of being used in standard formulas as a reasonable percentage of the formula and not produce can pressures in excess of the allowable can limits. The following will describe our initial testing using ethane as a propellant.

Ethane is a saturated hydrocarbon with the formula C₂H₆. We demonstrate herein that ethane can be effectively used as an aerosol propellant. Ethane may be used alone as an individual chemical or in blends with other saturated hydrocarbons propellants and solvents. Suitably ethane may be blended with hydrofluorocarbon (HFC) propellants and solvents, hydrofluoro-olefin (HFO) propellants and solvents, hydrofluoroether (HFE) propellants and solvents, aldehydes, ketones, esters, glycol ethers, and other solvents and propellants as found in all pressurized containers designated for aerosol use. In particular, ethane may be used in place of carbon dioxide in various continuous spray products. Ethane may also be used in combination with some of the newly developed and high cost propellants developed to reduce ozone depletion, VOC content and global warming potential of currently used propellants. Use of these newer compounds in combination with ethane may reduce the costs of producing finished products such that the use of these newer compounds can be extended into new consumer product fields.

Ethane is not considered a VOC and has very low global warming potential. Ethane is non-toxic, does not result in ozone depletion and is as safe as other hydrocarbon propellants. Ethane is also compatible with most solvents and propellants tested as shown in the Examples, including heptane, acetone, Conosol 200™ and isobutane. Solutions with 10-15% ethane were shown to dissolve in the products and maintain can pressures in the acceptable range. Even with additives like silicone, ethane levels of 3.5% were achieved. The Examples demonstrate that ethane can be used as a propellant for an aerosol or sprayable consumer product.

Provided herein are pressurizing or propellant compositions including at least 1% ethane by weight in which ethane is the only saturated hydrocarbon propellant in the composition. These compositions lacking another saturated hydrocarbon propellant may include at least 2%, 3%, 4%, 5%, 6%, 7%, 8%, 9%, 10%, 12%, 15%, 17%, 20% ethane by weight. The upper limit of ethane in the propellant composition is limited by the ability of the solvent and material to be sprayed to adsorb the ethane when the propellant is used in a product. Ethane comprises less than 30% of the propellant compositions described herein. Suitably, ethane is less than 25%, 22%, 20%, 18%, 15%, 12%, 10%, 7%, or 5% by weight of the propellant compositions. In some compositions a range of ethane may be suitable. Suitable ranges may be defined by combining any two of the above listed percentages. For example, the compositions may contain from 1-30%, 2-25%, 2-20%, 3-20% or any suitable range of ethane in the propellant. In some embodiments, ethane is the only propellant in the composition. In other embodiments, ethane is used in combination with one or more other propellants.

The propellant compositions provided herein may not contain a saturated hydrocarbon propellant other than ethane. In other embodiments, the propellant compositions may comprise ethane and may include other non-hydrocarbon based propellants such as HFOs, HFCs, HFEs or dimethyl ether (DME). The ethane propellant may be mixed or blended with other agents as well, including but not limited to, aldehydes, ketones, esters, ethers (such as glycol ether) and oxygenated solvents.

Also provided are pressurizing or propellant compositions including at least 5% ethane. These compositions may include at least 6%, 7%, 8%, 9%, 10%, 12%, 15%, 17%, 20% ethane by weight. In compositions comprising at least 5% ethane, the compositions may also comprise another hydrocarbon propellant or ethane may be the only hydrocarbon propellant. The upper limit of ethane in the propellant composition is limited by the ability of the solvent and material to be sprayed to adsorb the ethane when the propellant s used in a product. Suitably, ethane comprises less than 30% of these propellant compositions. Suitably, ethane is less than 25%, 22%, 20%, 18%, 15%, 12%, or 10% by weight of these propellant compositions. In some compositions a range of ethane may be suitable. Suitable ranges may be defined by combining any two of the above listed percentages. For example, the compositions may contain from 1-30%, 2-25%, 2-20%, 3-20% or any suitable range of ethane in the propellant. In some embodiments, ethane is the only propellant in the composition.

In compositions comprising at least 5% ethane by weight, an additional hydrocarbon propellant or solvent may be used. In particular ethane may be combined with propane, butane or isobutane in these propellant compositions. These compositions may also include a propellant in which the ethane is blended with an HFC, HFO, HFE or DME propellant or solvent. The ethane propellant may be mixed or blended with other agents including but not limited to aldehydes, ketones, esters, ethers or oxygenated solvents.

In the Examples and disclosure provided herein, ethane is shown to be a low cost means of accomplishing many of the goals of the propellant and aerosol product industry including reducing the VOC, toxicity, ozone depletion and global warming potential of aerosol products while maintaining their utility. As noted above, the pressurizing or propellant compositions described herein suitably include low levels of volatile organic compounds. Because ethane is not considered a VOC, it can be used as a propellant to generate products with low VOC. In one embodiment, ethane is used in combination with a propellant that is a VOC. The combination results in a product with suitably lower VOC as compared to using the VOC compound alone as a propellant. Suitably, the compositions are non-toxic to or have limited toxicity for humans and animals. Suitably, the propellant composition does not deplete ozone, because it does not contain chlorine or bromine. Suitably, the propellant composition has a Global Warming Potential (GWP) of less than 150. Suitably the GWP of the propellant composition is less 150, 125, 100, 90, 80, 70, 60, 50, 40, 30, 20, 10, or 5. Because ethane does not deplete ozone and has a low GWP, it can be combined with other commonly used propellants which may deplete ozone or have a higher GWP to decrease the ozone depletion and GWP levels of the finished combination propellant product.

The compositions may be mixed as a propellant or pressurizing composition which is then added to a product including a material to be sprayed in a proper container to make a continuous spray product. Thus also included herein are continuous spray products or aerosol products including the pressurizing or propellant compositions described herein. Ethane containing propellants may be used to replace carbon dioxide, or other hydrocarbon based propellants in many products. Unlike carbon dioxide, ethane may be used as a propellant in products that are water based, or based on a hydrocarbon solvent system.

The final concentration of ethane in the continuous spray product is at least 1%. Suitably the amount of ethane in the continuous spray product is at least 2%, 3%, 4%, 5% or 6%. In some continuous spray products ethane is the only hydrocarbon or the only hydrocarbon propellant in the product. Ethane may be considered the only hydrocarbon propellant in the product if the other hydrocarbons are liquid at standard temperature and pressure conditions. In other products, ethane is not the only hydrocarbon in the product. The products may contain hydrocarbon-based solvents and other hydrocarbon-based propellants. For example, ethane can be used in combination with butane.

Another important physical property associated with the dispensing of aerosol products is the vapor pressure of the propellant. Vapor pressure is the pressure exerted when a liquefied propellant gas is in equilibrium with its vapor in a closed container, such as an aerosol can. Vapor pressure can be measured by connecting a pressure gauge to the valve on an aerosol can or gas cylinder containing the vapor/liquid mixture. A standard of measurement of vapor pressure in the U.S. aerosol industry is pounds per square inch gauge (psig) with the gas/liquid mixture at constant temperature, most commonly at 70° F. When vapor pressure is mentioned herein without reference to temperature, it can be assumed that the pressure is determined at 70° F. The vapor pressures of liquefied gases most widely employed as aerosol propellants will be at least 16.3 psig or more. Suitably the psig of the product is 5, 10, 20, 30, 40, 50, 60, 70, 80, 90, 100, 110 psig or more at 70° F. Suitably, the psig of the product is less than 600, 550, 500, 450, 400, 350, 300, 250, 225, 200, 175, 150, 125, 100 or 90 psig at 130° F.

The propellant compositions described herein may preferably be formulated as a sprayable product. The propellant products preferably comprise a material to be sprayed and a propellant composition in accordance with the present invention. Inert ingredients, solvents, and other materials may also be present in the sprayable mixture. Preferably, the sprayable composition is an aerosol. Suitable materials to be sprayed include, without limitation, materials such as deodorants, perfumes, hair sprays, cleansers, insecticides, insect repellants, herbicides, lubricants, paint, coatings, and polishing agents. The products may be Consumer products. Medical products or Industrial products.

Aerosol products for industrial, consumer or medical use typically contain one or more propellants and may also contain one or more active ingredients, inert ingredients or solvents. The propellant provides the force that expels the product in aerosolized form. While some aerosol products are propelled with compressed gases like carbon dioxide, nitrogen, nitrous oxide and even air, most commercial aerosols use liquefied gas propellants. The most commonly used liquefied gas propellants are hydrocarbons such as butane, isobutane, and propane. Dimethyl ether, HFC-134 and HFC-152a (1,1-difluoroethane) are also used, either alone or in blends with the hydrocarbon propellants. The propellant compositions comprising ethane disclosed herein can be used to formulate a variety of industrial aerosols or other sprayable compositions such as contact cleaners, dusters, lubricant sprays, and the like, and consumer aerosols such as personal care products, household products and automotive products. Sprayable cleaners, pesticides and lubricants can be formulated using the propellant compositions described herein. Several examples of products comprising ethane as a propellant are provided in the Examples below.

The formulations and products containing ethane propellant compositions may contain, in addition: dispersing agents or solvents, such as water and various organic solvents: alcohols, glycols, chlorohydrocarbons, esters, ethers, aldehydes, and ketones, as, for instance: ethanol, ethyleneglycol, propyleneglycol, methylene chloride, ethyl ether, ethyl acetate, butyl acetate; auxiliary dispersing agents: surfactants of the ionic and non-ionic type, such as: triethanolamino laurylsulphate, polyethyleneglycols, diethyleneglycol, monostearate, benzyldodecyldimethylammoniumsulphate; glycerides; auxiliaries with a filling action such as e.g.: particular types of dispersed silica and talc; auxiliaries modifying the rheological properties such as certain cellulose derivatives and certain synthetic polymer derivatives, for instance, carboxymethylcellulose and polyvinylacetate; auxiliaries with a binding action such as for instance polyvinylpyrrolidone; active ingredients with an antiseptic action, or with a deodorizing, perfuming, pharmacological, pesticide, antipathogenous action; etc. Said active ingredients may belong to different classes of substances such as: aldehydes, ketones, aliphatic and aromatic alcohols, esters of higher acids, glycerides, terpenic derivatives, polychlorobenzenes, quaternary ammonium salts, carbanylides, phenol derivatives and thio-derivatives. These lists are not limiting and are meant to be exemplary.

The continuous spray products can be developed to be consumer friendly as well. Because they rely on the propellant compositions provided herein the products may have low VOC or no VOC. The products produced may have low toxicity or be non-toxic to humans and animals. The products may not deplete ozone. Finally, the products may have a Global Warming Potential (GWP) of less than 150. Suitably the GWP of the propellant composition is less 150, 125, 100, 90, 80, 70, 60, 50, 40, 30, 20, 10, or 5.

The present invention also provides methods of removing contaminants from a product, part, component, substrate, or any other article or portion thereof by applying to the article a composition of the present invention. For the purposes of convenience, the term “article” is used herein to refer to all such products, parts, components, substrates, and the like and is further intended to refer to any surface or portion thereof. Furthermore, the term “contaminant” is intended to refer to any unwanted material or substance present on the article, even if such substance is placed on the article intentionally. For example, in the manufacture of semiconductor devices it is common to deposit a photoresist material onto a substrate to form a mask for the etching operation and to subsequently remove the photoresist material from the substrate. The term “contaminant” as used herein is intended to cover and encompass such a photo resist material. Preferred methods of the present invention comprise applying the products described herein to the article. In some embodiments application of the product alone is sufficient to mediate cleaning of the article. In other embodiments, the article may be wiped, rubbed, scrubbed, polished, or washed with a solvent such as water or ethanol to effect cleaning by removal of the contaminant. Several cleaning product formulations are provided in the Examples and include gun cleaners, tire cleaners, degreasers and all-purpose cleaners. These are not an exhaustive list nor are they the only formulations for these products. Those of skill in the art will appreciate that many products may be made using ethane as a propellant.

All tests to date indicate that ethane would be beneficial for other products and blends not listed or specifically described herein. As an example, a blend of DME and ethane could be used in water based products that are not able to use carbon dioxide (CO₂) due to the carbonic acid produced in a water solution. Ethane could also be used to increase the pressure in a new HFO solvent or propellant, thus reducing the costs, and maintaining little or no flammability. Those of skill in the art will envisage other possible uses or combinations for using ethane as a propellant.

The following examples are meant only to be illustrative and are not meant as limitations on the scope of the invention or of the appended claims. All references cited herein are hereby incorporated by reference in their entireties.

### EXAMPLES

Using standard aerosol components, the amounts of ethane that would be adsorbed in some common chemicals while maintaining acceptable can pressures were measured. We introduced the ethane into each can with a standard gassing burette. All tests were conducted under standard laboratory conditions.

### Results

### Test #1—Products Made With Heptane Based Solvents

Heptane is a common hydrocarbon solvent and should provide good solubility for ethane. We wanted to determine the percent of ethane that could be dissolved in heptane and compare the results to a typical fill with CO₂ (2-4%). We were able to dissolve 15% ethane in Heptane at a can pressure of 115 PSIG.

### Test #2—Tire Shine Product

To determine the effect that an additive would have on the adsorption of ethane, we tested the ability to dissolve ethane in a material also containing a silicone additive. In this test, 15% silicone, which is commonly used in tire shine products, was added into the heptane to determine the effect on ethane adsorption. The addition of silicone reduced the amount of ethane adsorbed by the solution. However an ethane adsorption of 3.5% was achieved at a can pressure of 100 psig and the spray was a fine mist. Thus ethane was a suitable propellant for a tire shine composition.

Test#3—Conosol 200™ Insecticide Product

Many insecticides use a high flash non VOC petroleum solvent to meet regulatory requirements. Many of these formulas use CO₂ as the propellant, but it is difficult to get more than 2-3% in the can. We determined that using straight gassing, we were able to get 10% ethane into solution at 140 psig.

### Test #4—Products Made With an Acetone Based Solvent

Acetone is widely used in formulas due to its VOC exempt status. We were able to get 9% Ethane into a solution of acetone within the pressure limits of a standard can. This exceeds the levels of CO₂ normally attained.

### Test#5—Products Made With Isobutane Based Solvent

Propellant blends are commonly used to achieve different pressures in various aerosols. In today's aerosol products one will see blends with pressures from 17-110 psig. The common hydrocarbon propellants follow Gas Laws and the blends can be predicted based on the partial pressures of the individual components. We were able to dissolve 8.5% Ethane in Isobutane with a can pressure of 125 PSIG. The addition of other solvents would produce a lower pressure or allow more Ethane at the same pressure. This indicates that Ethane could be useful in producing blends that have pressures in the described range, but at lower reportable VOC levels.

Exemplary products produced using ethane as the propellant:

Silicone Lubricant

| Chemical | Wt. % |
|---|---|
| Silicone (60,000) | 10.00 |
| Heptane | 15.00 |
| Isopar M | 50.00 |
| Acetone | 15.00 |
| Ethane | 10.00 |
| | 100.00 |
| Low VOC formula | |

Wasp & Hornet Spray Insecticide

| Chemical | Wt. % |
|---|---|
| Insecticide | 3.00 |
| Isopar M | 90.00 |
| Ethane | 7.00 |
| | 100.00 |
| Low VOC | |

Aerosol Gun Solvent - Low Cost

| Chemical | Wt % |
|---|---|
| Odorless Kerosene or equivalent | 47.00 |
| Acetone | 10.00 |
| IPA | 5.00 |
| Mineral spirits | 30.00 |
| Ethane | 8.00 |
| | 100.00 |

The above lists the package concentrate which will be mixed with 8% by weight ethane. For cost savings, the hydrocarbon propellant can be used in the 46-70 psig range. Valves can generally use buna or neoprene gaskets. This product is a good general cleaner and does displace some moisture. It does not lubricate or protect metals.

Aerosol Gun Solvent - Premium

| Chemical | WT % |
|---|---|
| Odorless Kerosene | 37.00 |
| Butyl Cellosolve | 25.00 |
| IPA | 5.00 |
| 1,2 Trans Dichloroethylene | 10.00 |
| M-Pyrol | 5.00 |
| Acetone | 10.00 |
| Ethane | 8.00 |
| | 100.00 |

The above lists the package concentrate which will be mixed with 8% by weight ethane. Hydrocarbon propellant in the 46-70 psig range can be used. Spray characteristics and delivery determined by valve and actuator. This product is a good general cleaner, but does not lubricate or protect the metal.

Aerosol All Purpose Cleaner

| Chemical | WT % |
|---|---|
| Tween 20 | 3.00 |
| Biosoft D40 | 3.00 |
| Propylene glycol n-butyl ether | 5.00 |
| Pluronic L-61 | 0.34 |
| DI Water | Balance |
| A-17 | 2.00 |
| Ethane | 1.00 |

Aerosol Heavy Duty Cleaner/Degreaser

| Chemical | WT % |
|---|---|
| Span 20 | 5.00 |
| Pluronic 25R2 | 5.00 |
| Tween 20 | 5.00 |
| Biosoft D40 | 7.00 |
| Propylene glycol n-butyl ether | 10.00 |
| DI Water | Balance |
| A-17 | 2.00 |
| Ethane | 1.00 |

What is claimed is:

1. A pressurizing or propellant composition comprising at least 1% ethane by weight, wherein ethane is the only saturated hydrocarbon propellant in the composition.

2. The composition of claim 1, comprising between 1% and 30% ethane by weight.

3. The composition of claim 1, further comprising a hydrofluorocarbon propellant or solvent, hydrofluoro-olefin propellant or solvent, hydrofluoroether propellant or solvent, hydrocarbon propellant or solvent, aldehydes, ketones, esters, or glycol ethers.

4. The composition of claim 1, wherein the composition comprises low volatile organic compounds and minimal toxicity to animals and humans.

5. The composition of claim 1, wherein the composition has a Global Warming Potential (GWP) of less than 150.0 and does not deplete ozone.

6. A pressurizing or propellant composition comprising at least 5% ethane by weight.

7. The composition of claim 6, wherein ethane is the only hydrocarbon in the composition.

8. The composition of claim 6, further comprising an additional hydrocarbon propellant or solvent.

9. The composition of claim 6, further comprising a hydrofluorocarbon propellant or solvent, hydrofluoro-olefin propellant or solvent, hydrofluoroether propellant or solvent, hydrocarbon propellant or solvent, aldehydes, ketones, esters, or glycol ethers.

10. The composition of claim 6, wherein ethane comprises between 5% and 30% of the composition by weight.

11. The composition of claim 6, wherein the composition comprises low volatile organic compounds and minimal toxicity to animals and humans.

12. The composition of claim 6, wherein the composition has a Global Warming Potential (GWP) of less than 150.0 and does not deplete ozone.

13. A continuous spray product comprising the pressurizing composition of claim 1.

14. The product of claim 13, further comprising a material to be sprayed.

15. The product of claim 13, wherein the product is a deodorant, perfume, hair spray, cleanser, insecticide, insect repellant, herbicide, lubricant, paint, coating, or polishing agent.

16. The product of claim 13, wherein the product is packaged at less than 600 psig.

17. A continuous spray product comprising the pressurizing composition of claim 6.

18. The product of claim 17, wherein ethane is the only hydrocarbon propellant in the composition.

19. The product of claim 17, further comprising a material to be sprayed.

20. The product of claim 17, wherein the product is a deodorant, perfume, hair spray, cleanser, insecticide, insect repellant, herbicide, lubricant, paint, coating, or polishing agent.

21. The product of claim 17, wherein the product is packaged at less than 600 psig.

22. A method of removing a contaminant from an article or portion thereof comprising applying the product of claim 17 to the article, wherein the material to be sprayed is a cleaner or polisher.

23. A method of removing a contaminant from an article or portion thereof comprising applying the product of claim 13 to the article, wherein the material to be sprayed is a cleaner or polisher.
